(19) United States
(12) Patent Application Publication
(10) Pub. No.: US 2004/0169338 A1
(43) Pub. Date: Sep. 2, 2004

(54) Sealing ring

(76) Inventors: Gunter Hintenlang, Abtsteinach (DE); Szaboles Sebok, Kecskemet (HU); Jean Philippe Marchal, Chalindrey (FR)

Correspondence Address: HARNESS, DICKEY & PIERCE, P.L.C., P.O. BOX 828, BLOOMFIELD HILLS, MI, 48303, US

(21) Appl. No.: 10/756,168

(22) Filed: Jan. 13, 2004

(30) Foreign Application Priority Data
Jan. 25, 2003 (DE) 10302976.1

(51) Int. Cl. F16J 15/32

(52) U.S. Cl. 277/549

(57) ABSTRACT

A sealing ring wherein both the first and the second sealing lip are well protected from mechanical damage/destruction. The relatively more sensitive first sealing lip is particularly well protected and, in particular, is protected from exposure to service life-reducing contaminants. Furthermore, the production of the sealing lip is simple and economical.

### FIELD OF THE INVENTION

The invention relates to a sealing ring.

### BACKGROUND OF THE INVENTION

Sealing rings are generally known, for example from U.S. Pat. No. 3,254,898. In this publication is disclosed a sealing ring comprising a supporting ring and a first sealing lip made of an elastomeric material as well as a second sealing lip made of polytetrafluoroethylene, the second sealing lip being wedged against the supporting body without being bound to it.

### SUMMARY OF THE INVENTION

The object of the invention is to further develop a sealing ring of the above-described kind in a manner such that during its installation both the first and the second sealing lip are well protected from mechanical damage/destruction. The relatively more sensitive first sealing lip is to be particularly well protected. Moreover, the first sealing lip is to be protected from exposure to service life-reducing contaminants. Furthermore, the production of the sealing lip is to be simple and economical.

To reach the the above objective, a sealing ring is provided which comprises a supporting ring connected with a first sealing lip made of an elastomeric material, and a second sealing lip, which with the aid of a clamping plate, is wedged against the supporting body without being bound to it. The clamping plate acts as a first centering ring for the precentered installation of a machine element that is to be sealed, and is provided with an insertion slant which protrudes axially in the direction opposite to that of machine element installation and to the first sealing lip. The clamping plate has a diameter that increases in funnel-like fashion in the direction opposite to that of installation and to the first sealing lip.

The second sealing lip acts as a second centering ring for further precentered installation of the machine element and is located after the first centering ring in the direction of installation. Such a sealing ring has an advantage in that, during its installation and during its intended use, the relatively sensitive first sealing lip made of an elastomeric material is particularly well protected from damage/destruction. During the installation of the sealing ring, the machine element to be sealed, which in most cases is a shaft, is precentered by the clamping plate that acts as the first centering ring. The precentering is brought about by the fact that the machine element reaches an approximate first position relative to the first sealing lip. During the installation, the machine element passes the second sealing lip, which is made of a polymeric material and in the form of a circular plate, and is disposed across the element to be sealed. The second sealing lip acts as a centering ring. During installation, the inner radial edge of the second centering ring is deformed by the installation, in the direction of the first sealing lip. When the outer periphery of the machine element is enveloped by the second centering ring, the machine element is disposed in a more finely precentered second position relative to the first sealing lip. The sealing ring and the machine element are now already disposed essentially concentrically with respect to each other.

When the sealing ring and the machine element to be sealed are moved further in the direction of installation, the machine element, which is already concentric with the sealing ring, penetrates the relatively more sensitive first sealing lip. By the two-stage and overall very good precentering of the machine element relative to the sealing ring, the mechanical loads exerted on the first sealing lip during installation are very low, and the risk of damage/destruction of the first sealing lip during installation is minimized.

During the intended use of the sealing ring, the second centering ring acts as a second sealing lip which precedes the first sealing lip, in the direction of the surroundings, thus preventing the penetration of contaminants from the surroundings in the direction of the first sealing lip. As a result of the multiple function of the second sealing lip (second stage of machine element precentering during installation and preliminary sealing for the first sealing lip), the sealing ring consists of very few parts and can thus be produced in a simple and economic manner.

The first sealing lip is preferably precurved axially in the direction of installation and axially in the direction of the space to be sealed. Such a design is particularly useful in reaching the afore-said objective.

The second sealing lip preferably consists of PTFE and is precurved axially in the direction of installation and axially in the direction of the first sealing lip. PTFE is particularly well suited for the two functions of the second sealing lip. Namely, PTFE is well suited for the further precentering of the machine element and the subsequent protection of the first sealing lip from contaminants from the surroundings. As a result of the memory effect of PTFE, this material resumes its original shape after having been subjected to deformation.

In the case described here, the plate produced in an original circular shape and after installation of the machine element elastically precurved radially on the inside in the direction of the first sealing lip, has a tendency to resume its original form. As a result, the surface of the machine element that is to be sealed is enveloped by the second sealing lip under initial radial tension. This results in particularly good mutual centering of the sealing ring and the machine element. Moreover, PTFE is well suited as a sealing material. That is, after a negligibly small initial wear in the region of the contact surface between the second sealing lip and the machine element to be sealed, the surface of the second sealing lip made of PTFE becomes glazed, thus showing very little wear and high resistance.

Viewed in longitudinal cross-section, the supporting ring can be essentially T-shaped and have a radial leg to which the first sealing lip is fixed. A supporting ring of this shape can be produced in a simple and economic manner. The supporting ring preferably consists of a metallic material, but it can also be made of some other tough material.

Preferably, the radial leg is completely covered by the elastomeric material of the first sealing lip. In such a case, the cover represents an outstanding advantage in that it provides protection against corrosion, particularly when the medium to be sealed can attack the material of which the supporting ring is made.

On its outer periphery, the supporting ring can be enveloped by a statically loaded seal consisting of an elastomeric material. The static seal can form a single piece with the first sealing lip and it can be made of the same material as the lip. The static seal, for example, touches, with elastic initial tension, the wall that delimits an opening of the housing.

The clamping ring, also viewed in longitudinal cross-section, can be C-shaped and axially open in the direction opposite to the installation direction. With its radially outer leg, the clamping ring can be pressed into the axially projecting part of the supporting ring. The clamping plate provides initial precentering during the installation of the sealing ring and of the machine element. At the same time, the clamping plate holds, in its position, the second sealing lip that acts as a second centering ring.

Preferably, the clamping plate is made of spring steel. This has the advantage that the insertion slant is springy, namely highly elastic. In this manner, the installation of the sealing ring and of the machine element to be sealed is substantially simplified. Undesirable plastic deformation of the insertion slant during installation is thus prevented.

### BRIEF DESCRIPTION OF THE DRAWING

FIG. 1 is a cross-sectional view of the sealing ring according to the present invention.

### DETAILED DESCRIPTION OF THE PREFERRED EMBODIMENTS

In the following description, a practical example of the sealing ring of the invention will be described by reference to the drawing.

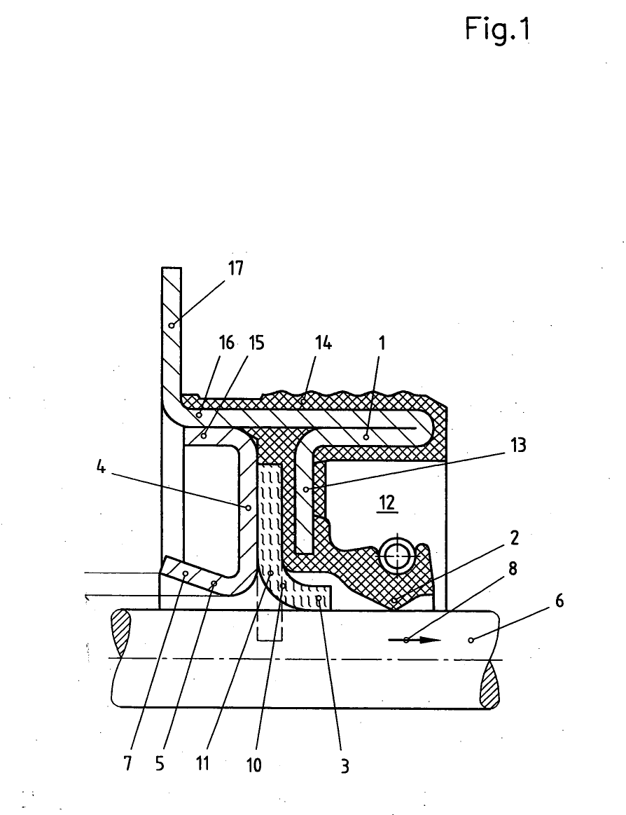

In FIG. 1, the sealing ring is shown in an installed condition during its intended use. The sealing ring comprises a supporting ring 1 made of a metallic material. On radial leg 13 is a vulcanized first sealing lip 2, made of an elastomeric material. Supporting ring 1, viewed in longitudinal cross-section, is T-shaped and, on its outer periphery, is enveloped by a statically loaded seal 14 which, in the practical example shown here, seals a housing opening (not shown). On the side facing axially away from a space 12 that is to be sealed, the supporting ring 1 is provided with a radial flange 17 that can touch the outer side of a housing wall. This radial flange 17 acts as a stop and, when touching the housing wall, brings about an exact positioning of the sealing ring in axial direction to the housing and machine element 6 that is to be sealed.

On the side of radial leg 13 facing away from the space 12 to be sealed, is disposed the second sealing lip 3 made of PTFE that acts as a second centering ring 10 for further precentered installation of the machine element 6. In the practical example shown here, the machine element 6 is a shaft.

Within the sealing ring, the second sealing lip 3 is held by clamping plate 4, without being bound to it.

Clamping plate 4 acts as a first centering ring 5 and comprises an insertion slant 7 that projects axially against an installation direction 8 of machine element 6 and first sealing lip 2. The insertion slant 7 has a diameter which widens in a funnel-like fashion axially in the direction opposite to installation direction 8 and first sealing lip 2.

The second sealing lip 3, acting as second centering ring 10, is located after the first centering ring 5 in the installation direction 8 and, in addition, acts as preliminary seal 11 for first sealing lip 2.

The entire disclosure of German Patent Application DE 103 02 976.1-12 is hereby incorporated by reference, in its entirety.

What is claimed is:

1. A sealing ring comprising:
a supporting ring connected with a first sealing lip made of an elastomeric material and a second sealing lip made of a polymeric material, said second sealing lip being wedged against the supporting ring by a clamping plate without being bound to it;
said clamping plate for purposes of precentered installation of a machine element that is to be sealed into the sealing lip, the clamping plate being provided with an insertion slant that projects axially in a direction opposite to that of an installation direction of the machine element and of the first sealing lip, and having a diameter that increases in funnel-like fashion axially in the direction opposite to the installation direction and to the first sealing lip; and
the second sealing lip acts as a second centering ring for further precentered installation of the machine element and being located after the first centering ring in the installation direction, and acting as preliminary seal for the first sealing lip.

2. The sealing ring according to claim 1, characterized in that the first sealing lip is precurved axially in the installation direction and axially in the direction of the space to be sealed.

3. The sealing ring according to claim 1, characterized in that the second sealing lip is made of PTFE and is precurved in the installation direction and axially in the direction of the first sealing lip.

4. The sealing ring according to claim 1, characterized in that the supporting ring is essentially T-shaped and is provided with a radial leg to which the first sealing lip is fixed.

5. The sealing ring according to claim 4, characterized in that the radial leg is completely enveloped by the elastomeric material of the first sealing lip.

6. The sealing ring according to claim 1, characterized in that the supporting ring is surrounded on its outer periphery by a statically loaded seal.

7. The sealing ring according to claim 6, characterized in that the static seal is made of an elastomeric material.

8. The sealing ring according to claim 6, characterized in that the static seal forms a single piece with the first sealing lip and can be made of the same material as said lip.

9. The sealing ring according to claim 1, characterized in that the clamping plate is C-shaped and axially open in the direction opposite to that of installation.

10. The sealing ring according claim 1, characterized in that the clamping ring is pressed into the axial projection of the supporting ring with its radially outer axial leg.

11. The sealing ring according to claim 1, characterized in that the clamping ring is made of spring steel.
